(19) United States
(12) Patent Application Publication
(10) Pub. No.: US 2007/0262229 A1
(43) Pub. Date: Nov. 15, 2007

(54) CONCRETE MOLD BOX ASSEMBLY WITH POLYURETHANE BONDED COMPARTMENTS

(75) Inventors: Douglas V. High, Vancouver, WA (US); Stacy L. Gildersleeve, Vancouver, WA (US); Llewellyn L. Johnston, Vancouver, WA (US)

Correspondence Address: MARGER JOHNSON & MCCOLLOM, P.C., 210 SW MORRISON STREET, SUITE 400, PORTLAND, OR, 97204, US

(73) Assignee: COLUMBIA MACHINE, INC., Vancouver, WA (US)

(21) Appl. No.: 11/746,022

(22) Filed: May 8, 2007

Related U.S. Application Data
(60) Provisional application No. 60/799,418, filed on May 9, 2006.

(51) Int. Cl. B29C 33/56; B28B 7/24; B29C 33/40

(52) U.S. Cl. 249/114.1; 249/119; 264/219

(57) ABSTRACT

A mold for concrete products includes a grid with a plurality of cavities that are open to both sides of the grid. The grid is bonded with polyurethane about its perimeter to the inner perimeter of a frame having a central opening therein. The grid may be formed of a single unitary piece or it may be formed from a plurality of sub-grids that are each bonded to the other with polyurethane.

### 1. FIELD OF THE INVENTION

The present invention relates to molds for concrete products such as blocks, bricks, or pavers and methods for making such molds.

### 2. BACKGROUND OF THE INVENTION

Concrete products are typically molded by machines that mold a plurality of products at a time. The machines incorporate molds that usually comprise a grid of cavities formed through a unitary body with the cavities opening to both the upper and lower surface of the body. The grid is usually welded into a frame that in turn is attached to the machine with the grid and frame together comprising the mold. The machine holds the mold with a plate on the lower side to support wet concrete that is dropped into each of the mold cavities. The mold and wet product are then vibrated and compressed, usually by shoes that lower into the cavities from their upper sides. Thereafter the plate is removed, and the molded products are pushed out the lower side of the mold and sent to be cured.

The molds usable in such machines are interchangeable because many different shapes and sizes of product can be formed in this way. In addition, the size of the mold, i.e., how many products can be formed at a time, varies depending upon the size of the machine in which the mold is installed. As a result, many molds must be made to accommodate varying products shapes and sizes and varying mold sizes.

Because of the extensive wear that the grids are subject to, they must be heat treated to harden the metal from which they are made. After heat treatment, if the grid is welded, hardness of the grid is substantially reduced. Grids are often machined from a unitary piece of metal. To provide a way for the grid to be mounted on the frame without damaging it, a large perimeter of metal is left around the circumference of the grid. The outermost portions of the metal on the perimeter can be welded to the frame without damaging the grid. But this reduces grid area in which more product cavities could be provided, which would improve product throughput for the machine.

Some mold grids are so large that heat treating them becomes problematic. As a result, it would be desirable to combine smaller grids into a single frame. This would also facilitate assembling different mold sizes from smaller grids. In other words, it would not be necessary to create a different sized grid for each mold size. Rather they could be assembled from smaller grids that could be used in various combinations to create grids of different sizes.

### BRIEF DESCRIPTION OF THE DRAWINGS

FIG. 1 is a perspective view of a mold box assembly constructed in accordance with the present invention.

FIG. 2 is an enlarged, exploded perspective view of one of the FIG. 1 cavity subassemblies for molding a single concrete product.

FIG. 3 is an assembled view of the form of FIG. 2 showing tack weld locations for assembling all of the cavity subassemblies.

FIG. 4 is a partial bottom view of a portion of the mold box assembly of FIG. 1.

FIG. 5 is a view along line 5-5 in FIG. 4.

FIG. 6 is a top plan view of another embodiment of a mold box assembly according to the invention.

FIG. 7 is a view along line 7-7 in FIG. 6.

FIG. 8 is an enlarged view of a portion of FIG. 7.

FIG. 9 is an exploded perspective view of the mold box assembly of FIG. 6.

FIG. 10 is an assembled perspective view of the mold box assembly of FIG. 9.

FIG. 11 is a top plan view of another embodiment of a mold box assembly according to the invention.

FIG. 12 is a side right side view of the embodiment of FIG. 11.

FIG. 13 is a sectional view along line 13-13 in FIG. 11.

FIG. 14 is an enlarged view of a portion of FIG. 13.

FIG. 15 is an enlarged view of another portion of FIG. 13.

FIG. 16 is an exploded perspective view of the mold box assembly of FIG. 11.

FIG. 17 is an assembled perspective view of the mold box assembly of FIG. 16.

FIG. 18 is a top plan view of another embodiment of a mold box assembly according to the invention.

FIG. 19 is a view along line 19-19 in FIG. 18.

FIG. 20 is an enlarged view of a portion of FIG. 19.

FIG. 21 is an enlarged view of another portion of FIG. 19.

FIG. 22 is an exploded perspective view of the mold box assembly of FIG. 18.

FIG. 23 is an assembled perspective view of the mold box assembly of FIG. 22.

FIG. 24 is a top plan view of the assembled grid from the mold box of FIG. 18.

FIG. 25 is a side elevation view of the grid of FIG. 24.

FIG. 26 is a view along line 26-26 in FIG. 24.

FIG. 27 is an enlarged view of a portion of FIG. 26.

FIG. 28 is an enlarged view of a portion of FIG. 24.

FIG. 29 is a perspective view of the grid of FIG. 24.

FIG. 30 is an exploded perspective view of the grid of FIG. 29

FIG. 31 is an enlarged view of a portion of FIG. 30.

### DETAILED DESCRIPTION OF THE DRAWINGS

Indicated generally at 10 is a mold box assembly constructed in accordance with the present invention. It includes a frame 12 and a plurality of cavities, like cavities 14, 16, 18. Frame 12 comprises a solid metal block having a substantially rectangular void formed therethrough to receive metal walls, like walls 20, 22, that define each of the cavities.

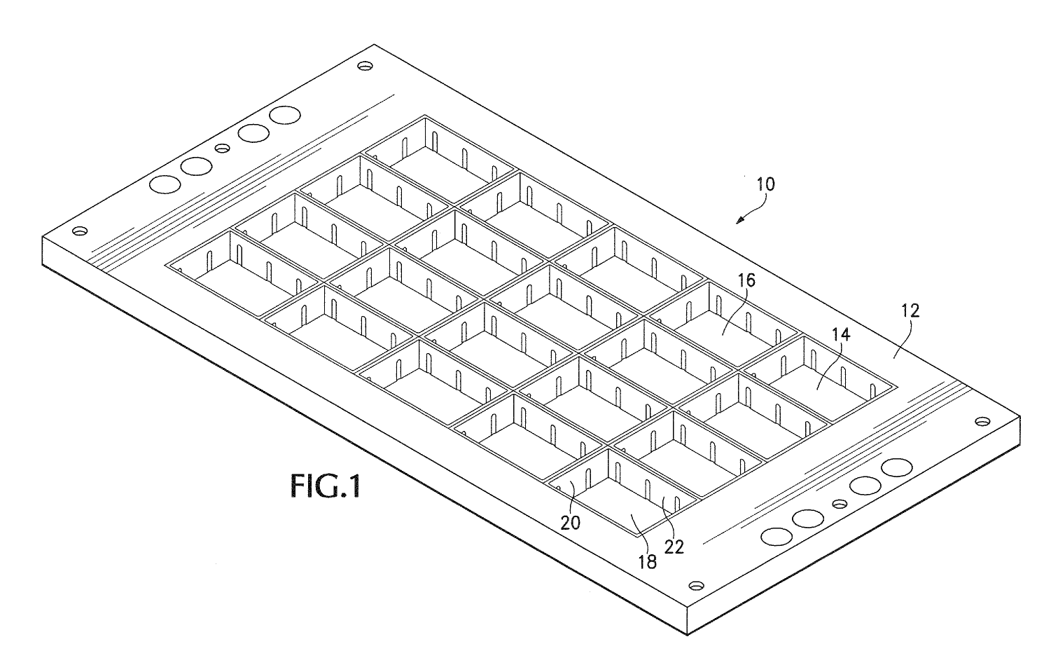

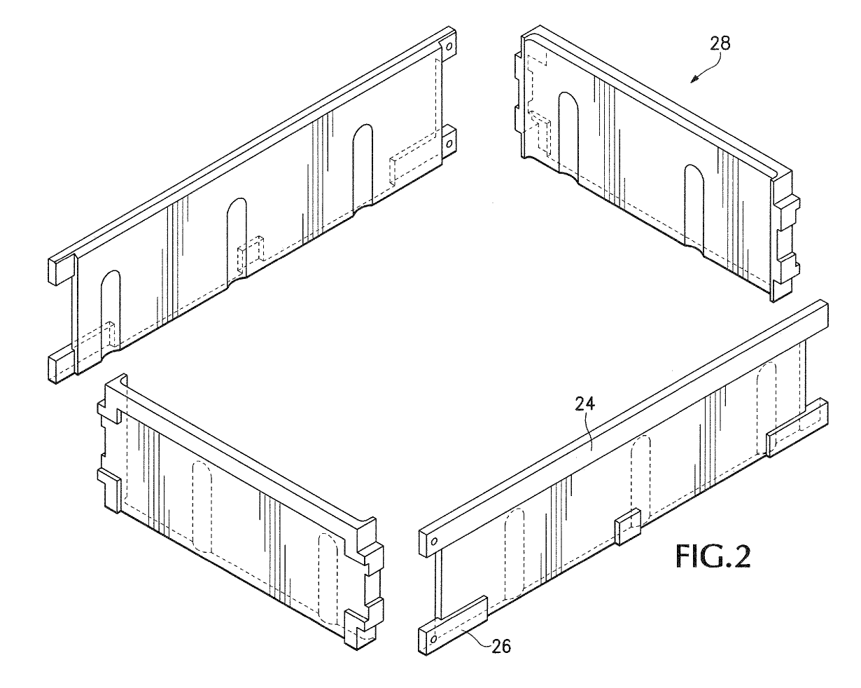

FIG. 2 depicts an exploded view of four of a cavity subassembly 28. Cavity subassembly 28 includes the walls that define one of the cavities in FIG. 1. As can be seen, metal straps, like straps 24, 26, are attached to each wall. The walls and straps are placed around a rectangular form and welded together to create the assembled cavity subassembly 28, as shown in FIG. 3. Also included is a brace 30 that butts against a corresponding brace on an adjacent cavity subassembly or the frame wall when the mold box assembly is assembled as shown in FIG. 1.

When assembling a plurality of substantially identical cavity subassemblies to the configuration of FIG. 1, each subassembly is tack welded to another at their corners, as shown by the tack weld locations in FIG. 3. Such welding continues until the subassemblies are in the form shown in FIG. 1.

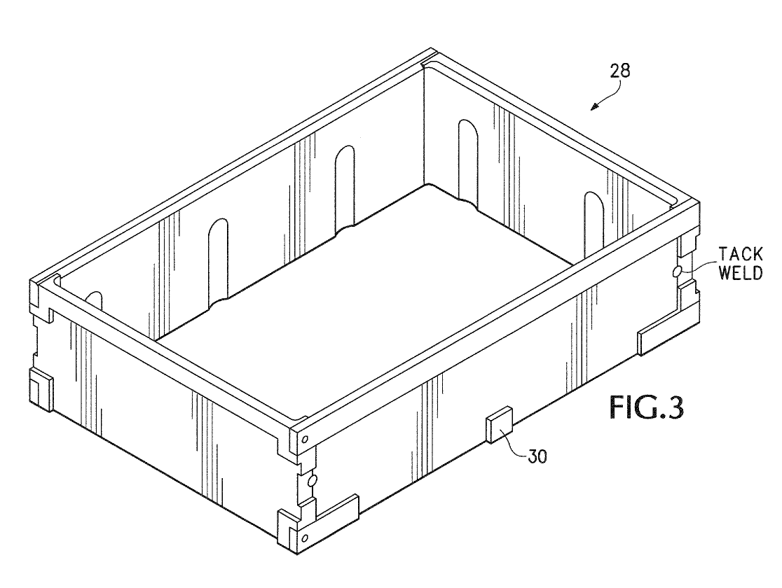

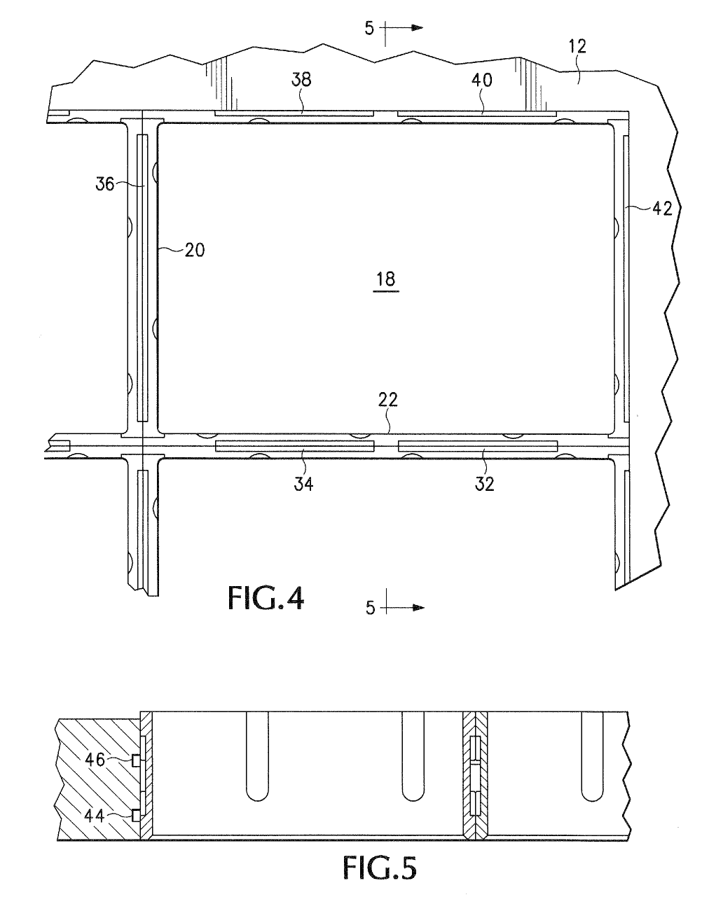

To finally assemble, frame 12 is placed upside down on a heated table and the tack welded cavity subassemblies are lowered—also upside down—into the opening in the frame. The view of FIG. 4 is shown looking down on the assembled frame and subassemblies while supported on the heated table.

Also in FIG. 4, a plurality of void fill areas 32, 34, 36 are formed between the exterior walls of the cavity subassembly and adjacent subassemblies. In a similar fashion, a plurality of void fill areas 38, 40, 42 are formed between the exterior walls of the cavity subassembly and the walls of the void in frame 12.

Next, a suitable polymer, such as polyurethane, is mixed and poured into the voids between each cavity subassembly and between the inner wall of frame 12 and the walls of the cavity subassemblies bordering the frame wall. For example, with reference to FIG. 4, polyurethane is received in void fill areas 32, 34, 36, 38, 40, 42. Grooves 44, 46 formed along the frame wall facilitate dispersal of polyurethane between the walls of the perimeter cavity subassemblies and the frame wall.

As can be seen in FIG. 3, when all of the voids are so filled, polyurethane fills the space defined between the straps and brace 30 of adjacent subassembly cavities. As mentioned, brace 30 butts against either the frame wall or the brace of an adjacent cavity subassembly. The brace thus prevents the subassembly walls from bowing under pressure from the polyurethane.

As can also be seen in FIG. 3, each of the tack welds are formed in a notch area that permits polyurethane to flow into the void formed between an adjacent pair of cavity subassemblies—or, for the cavity subassemblies bordering the frame wall, into the void formed between an adjacent subassembly and the frame wall. As a result, after all of the voids are filled, polyurethane covers substantial portions of each subassembly wall between the cavity subassemblies and between the exterior subassemblies and frame wall. When the polyurethane sets, the mold box assembly is ready to produce concrete products, such as pavers, in a known manner.

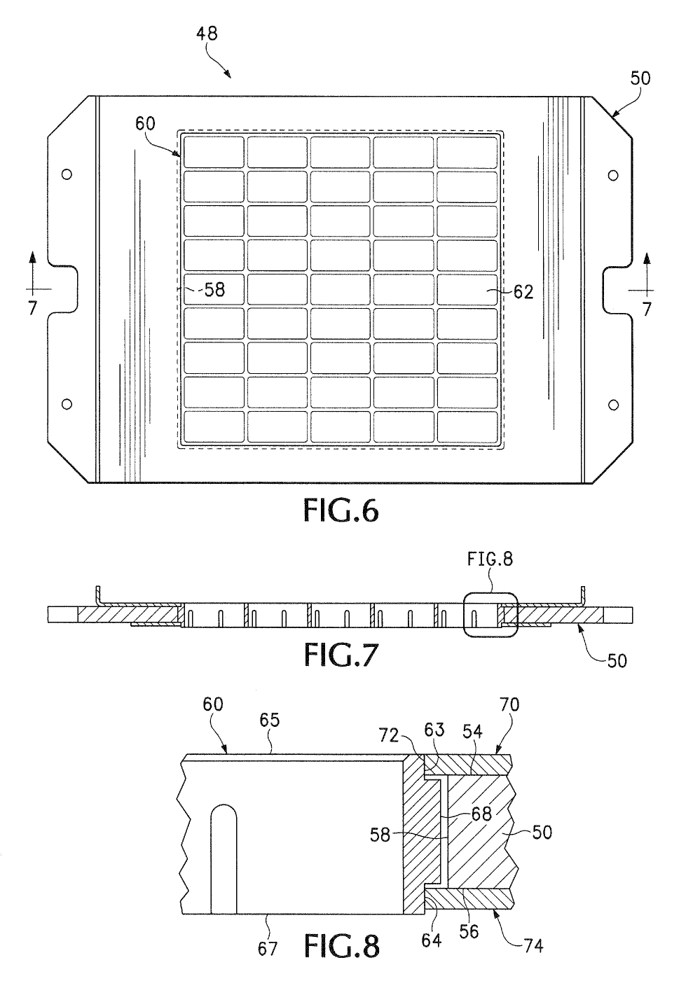

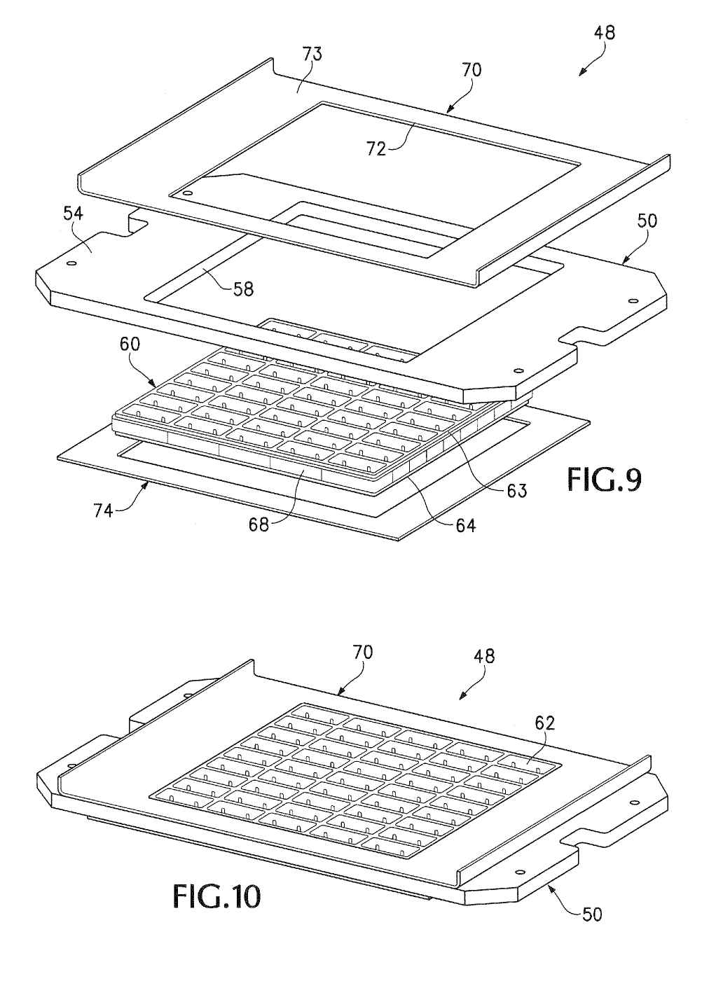

Turning now to FIGS. 6-10, indicated generally at 48 is another mold according to the present invention. Mold 48 includes a rectangular metal frame 50 having an upper surface 54 and a lower surface 56 (FIG. 8). A wall 58, which defines a central opening in the frame, extends between upper surface 54 and lower surface 56.

A grid 60 machined from a block of metal is received within the central opening of frame 50. As will be explained in more detail, a polymeric adhesive, preferably polyurethane, secures grid 60 to frame 50 about the perimeter of wall 58. The grid includes a plurality of cavities, like cavity 62, for forming concrete products—in this case, pavers—in a known manner. The cavities are open at both an upper surface 65 (FIG. 8) and a lower surface 67 of grid 60 for making concrete product in a known manner. The outer perimeter of the grid is machined to form upper and lower notches 63, 64 about the outer perimeter of the grid. A surface 68 between notches 63, 64 comprises the outermost perimeter of grid 60. A top retainer plate 70 is secured to top surface 54 of the frame. Plate 72 includes an upper surface 73 and a central opening defined by an inner perimeter 72. An optional bottom retainer plate 74, also having a central opening, may be secured to the lower surface of frame 50 as shown.

When making mold 48, frame 50 and grid 60 are machined in a known manner. The bottom surface of top plate 70 is applied to frame 50 as shown in FIG. 8. Frame 50 and grid 60 are first preheated in an oven. After preheating, top surface 73 of plate 70 is placed against a heated table of the kind used for polyurethane bonding. It is important that all of the components be thoroughly cleaned to make a secure polyurethane bond. Next, grid 60 is placed upside down within central opening 72 of plate 70. The grid is positioned so that the inner perimeter 72 of plate 70 abuts against notch 63 of the grid about the perimeter of plate 70 and grid 60, as shown in FIG. 8. As a result, a slot is formed about the perimeter of the grid having opposing surfaces defined by wall 58 of frame 50 and surface 68 of the grid. Plate 70 forms one end of the slot with the other being open because bottom plate 74 is not yet in place.

Polyurethane having an A scale durometer in the range of about 75-80 is poured into the slot around the circumference until the slot is full. The durometer determines the degree of hardness of the polyurethane. If the durometer is too low, the polyurethane bond is too flexible, which may result in the bond tearing as the mold is vibrated. If it is too high, the bond is too hard, which may result in the bond cracking under vibration. The durometer for a particular mold may depend upon the size and mass of the mold and the degree of vibration to which it is subject. The larger the mold, the greater the durometer should be.

Next, the optional bottom plate 74 is placed into position as shown in FIG. 8. Bottom plate 74 protects the polyurethane seal, but it may not be necessary to do so. In any event, after the polyurethane is poured, the mold is returned to the oven where it slowly cools overnight. After curing, the mold is ready for use.

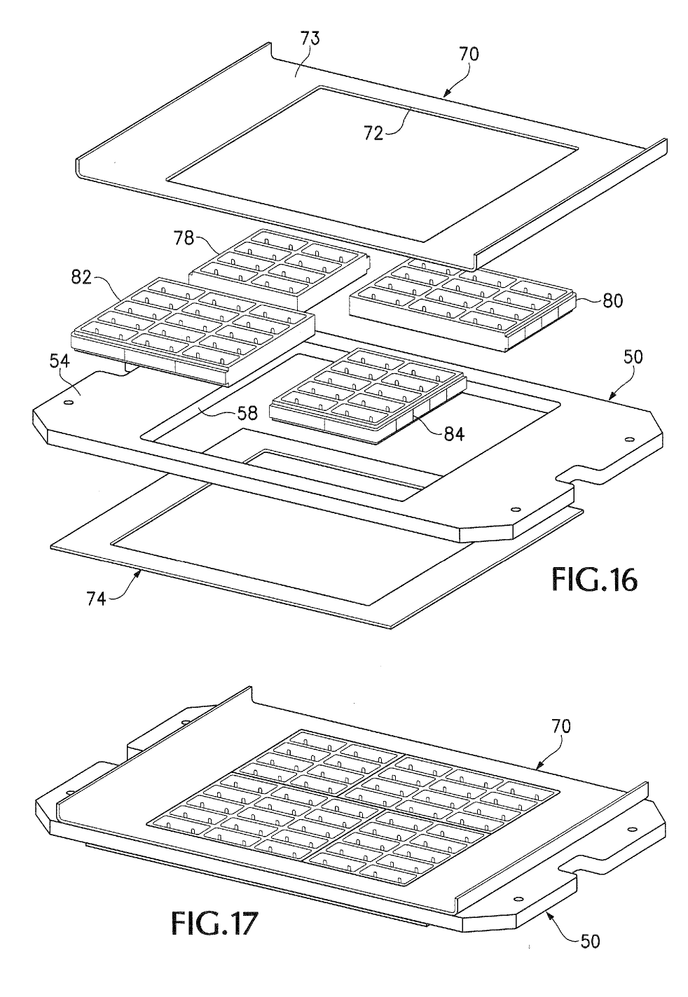

Turning now to FIGS. 11-17, consideration will be given to another embodiment of a mold box assembly according to the invention. Numbers used to identify structure in the embodiment of FIGS. 6-10 are used to identify corresponding structure in the embodiment shown in FIGS. 11-17. In FIG. 11, a grid 76 is structured similarly to grid 60 in the previously described embodiment. But grid 76 is made up of separately fabricated sub-grids 78, 80, 82, 84, as seen in the exploded view of FIG. 16.

Where adjacent sub-grids abut one another, like sub-grids 82, 84 in FIG. 14, a vertical face, like faces 86, 88, is formed near the upper surface of each sub-grid. Beneath each face, a corresponding wall recess, like recesses 90, 92 is formed. As a result, when the adjacent sub-grids are urged together, faces 86, 88 abut one another thus defining a slot that opens downwardly (in the view of FIG. 14) between recesses 90, 92.

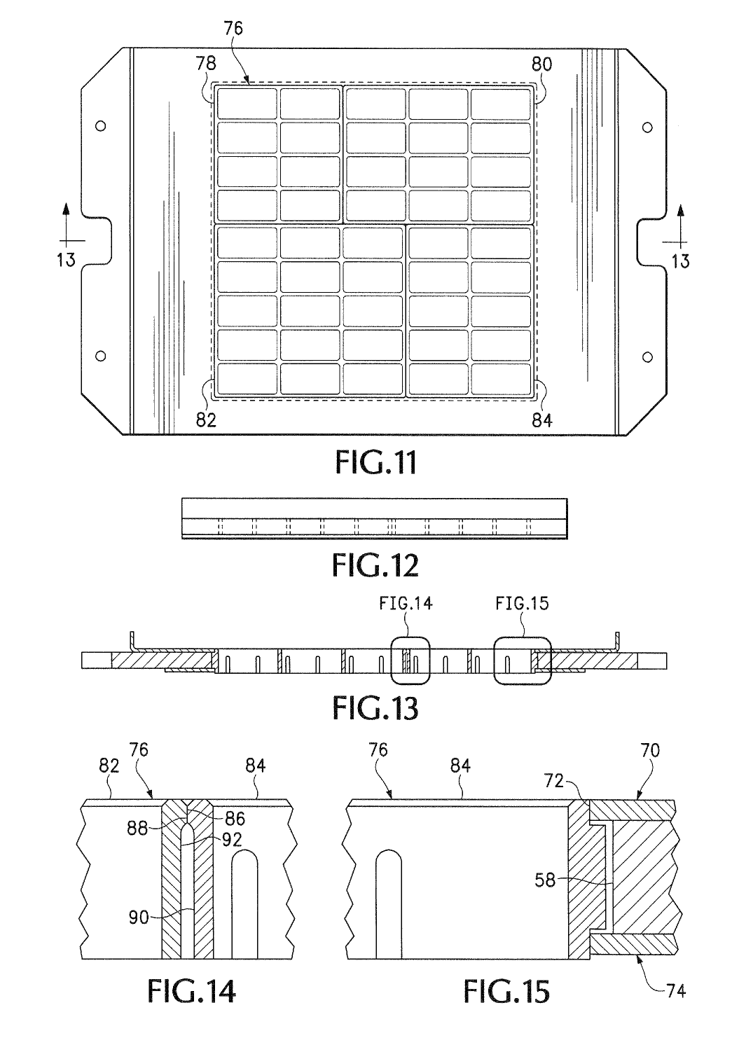

When the sub-grids are urged together as shown in FIGS. 11 and 17, the outer perimeter of the complete grid 76 is shaped similarly to the outer perimeter of grid 60 in the previously described embodiment, as can be seen by comparing FIGS. 15 and 8.

When making the mold of FIG. 17, top surface 73 is placed against the heat table with sub-grids 78, 80, 82, 84 assembled together to fit within opening 72 of top plate 70. The sub-grids consequently form a relationship with plate 70 as shown in FIG. 15, only upside down. This also exposes the slots defined between the recesses, like recesses 90, 92, in each adjacent sub-grid. In other words, the juncture of each sub-grid is as shown in FIG. 14, except upside down.

With the slot about the outermost perimeter of grid 76 and the slots between each sub-grid that forms grid 76 thus exposed, polyurethane is poured into all of the slots and cured as described above. The optional bottom plate may be added, and the mold is ready for use.

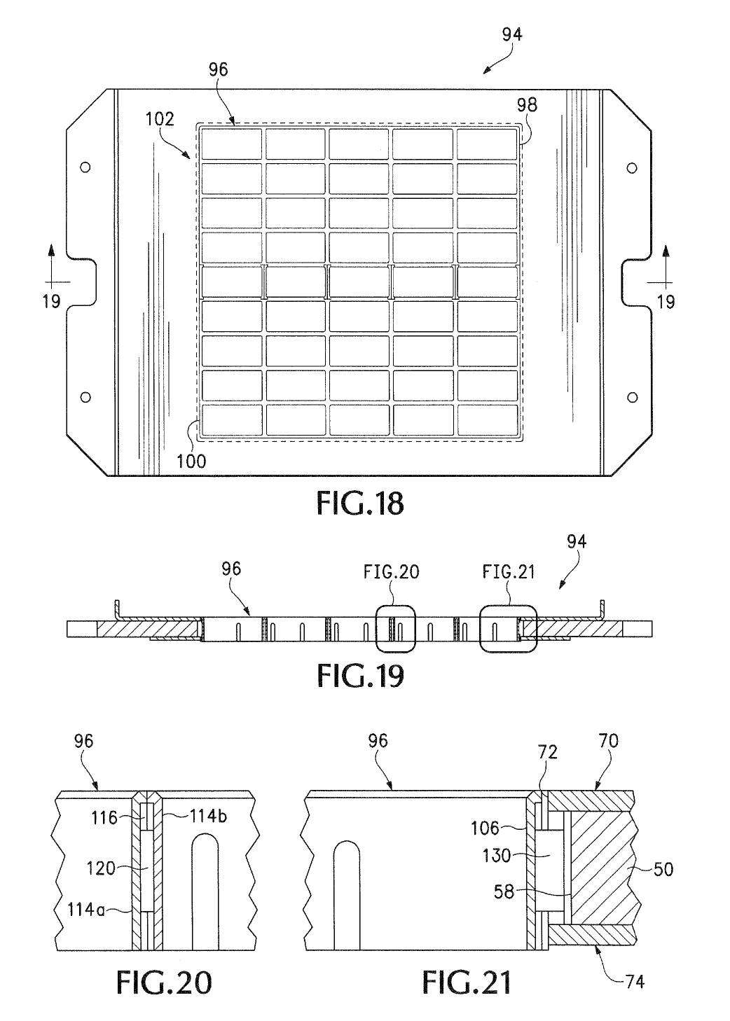

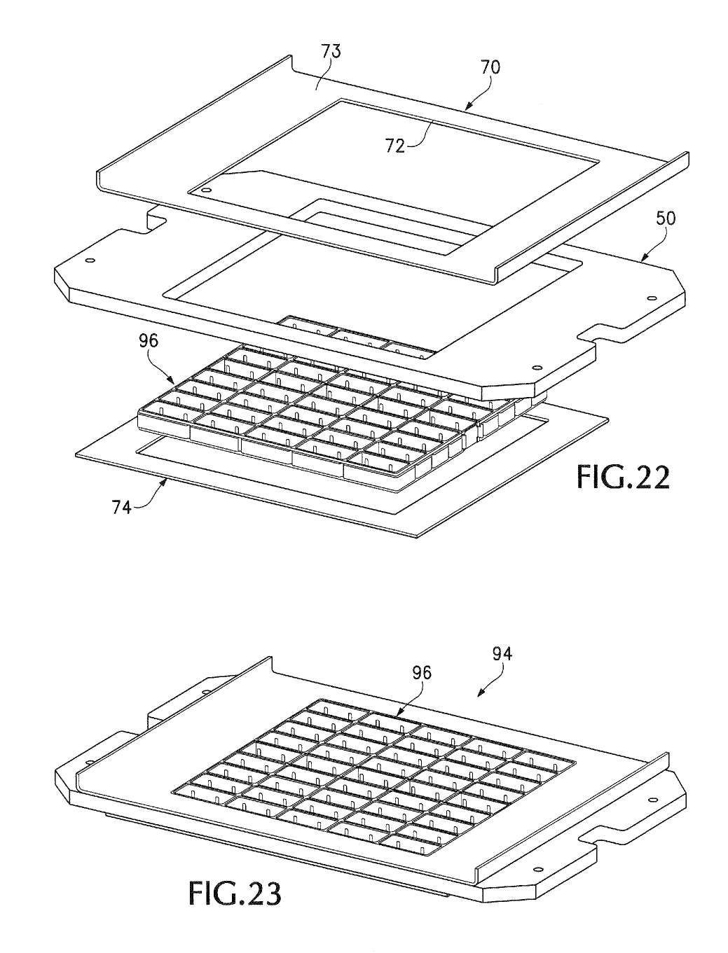

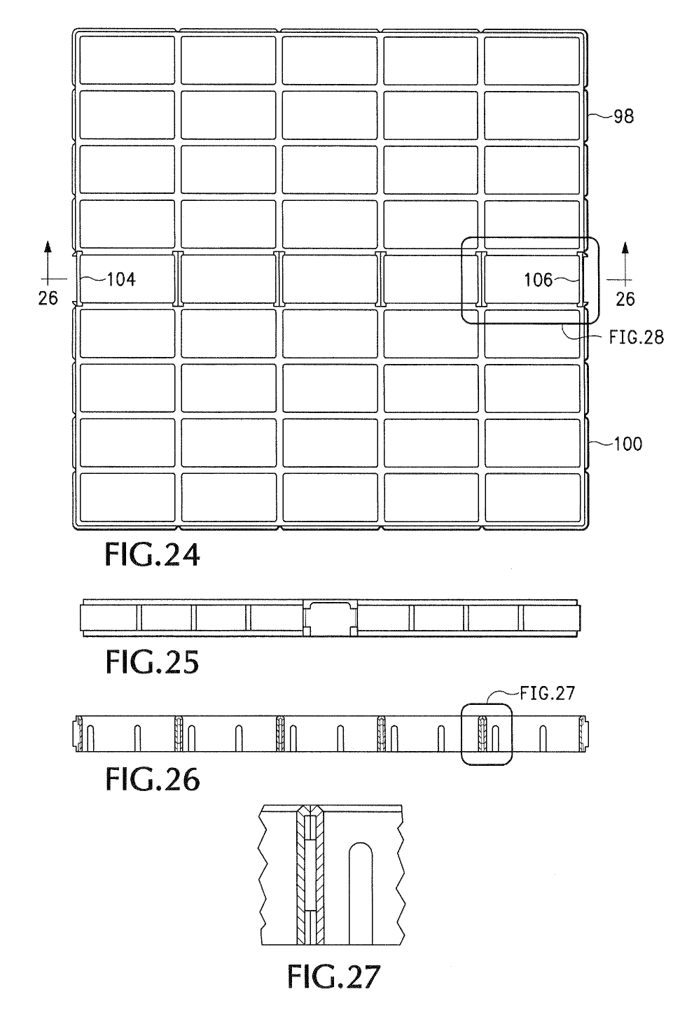

Turning now to the remainder of the drawings, consideration will be give to another embodiment of a mold box assembly according to the invention. Indicated generally at 94 in FIG. 18 is a mold that includes a grid 96. Mold 94 differs from the previously described embodiments primarily because grid 96 comprises two sub-grids 98, 100 (best seen exploded in FIG. 30) that are linked together via plates, indicated generally at 102 in FIG. 30, in a manner that will be described shortly.

Considering first plates 102 in FIG. 30, single plates 104, 106 are used to bridge the space between sub-grids 98, 100 along an outer perimeter of grid 96. Plate pairs 108a, 108b; 110a, 110b; 112a, 112b; and 114a, 114b are used to bridge the space between the sub-grids. As can be seen in FIGS. 20 and 31, each of the plate pairs includes a button, like button 116 (in FIG. 20) on plate 114a, at each of the four corners on one side of the plate. For example, in FIG. 30, all four buttons on each of plates 110a, 112a are visible. As can be seen in FIG. 20, when the plate pairs, like plate pair 114a, 114b are urged against one another, the buttons abut one another and define a void 120 (FIGS. 20 and 31) into which polyurethane is poured as will be described.

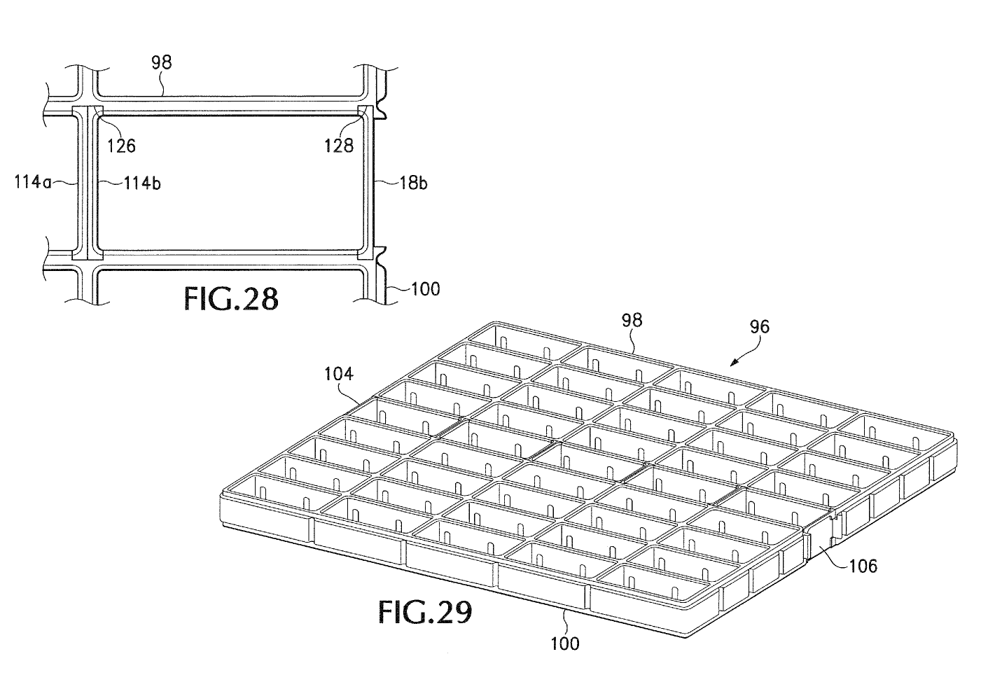

The plates also include vertical faces, like face 122 on plate 114a and face 124 on plate 114b, at each corner. As can be seen in FIG. 31, when the buttons of a plate pair are urged together, the faces, like faces 122, 124 can be received in a corresponding slot, like slot 126 in FIG. 31. Additional slots at both the top and bottom where sub-grids 98, 100 face one another can be seen in FIG. 30. Smaller slots, like slot 128 (FIG. 28), are formed for receiving the single faces of plates 104, 106. The slots for each of the plate pairs each receive a slot from both plates in the pair. As a result, these slots, like slot 126, are larger than the slots, like slot 128, for end plates 104, 106.

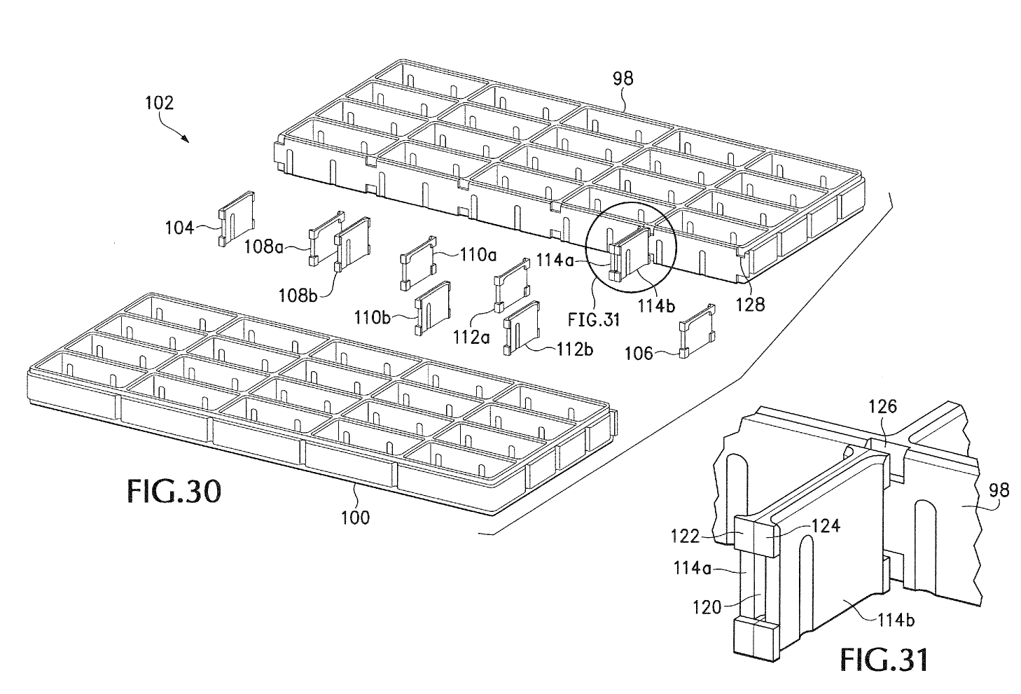

When making mold 94, top plate 70 is placed with surface 73 down on the heat table. Grid 96 is assembled upside down within opening 72 of the top plate. This includes positioning the plate in each plate pair 108, 110, 112, 114 so that the plates are aligned and the buttons on each opposing plate in the pair are urged against the buttons on the other plate, as shown for plate pair 114 in FIG. 31. The plate pairs are then positioned between sub-grids 98, 100 as are each of the single plates 104, 106. The sub-grids are moved together until all of the plate faces, like faces 122, 124 in FIG. 31 are received in a corresponding slot, like slot 126, in one of the sub-grids. When so assembled, the grid 96 is configured as shown in FIG. 29, except upside down and received within opening 72 of top plate 70.

As can be seen in FIG. 20 when so configured on the heat table, a void 120, which is referred to herein as a slot, is formed between each plate pair. The upward facing portion of the slot, which is on the lower side of the view of FIG. 20, presents an opening between the buttons on that side. The bottom of the slot, which is formed where the opposing plates meet one another, is closed.

Another slot visible in FIG. 2 is formed about the perimeter of the junction between grid 96 and frame 50. This is similar to the slot formed in previously described embodiments, except that the void into which polyurethane is poured is larger at each of plates 104, 106 because the plate is inset from the outer wall of sub-grids 98, 100. This leaves a larger void 130 (FIG. 21) between each of plates 104, 106 and the wall 58 of frame 50 than elsewhere around the perimeter of grid 96. It should be appreciated that inner perimeter 72 constrains the entire grid 96 in the position just described, as with the previous embodiments. Next, polyurethane is poured into the slots between the plate pairs, i.e., into the voids like void 120, and into the slot around the perimeter of grid 96, including the voids, like void 130 adjacent each single plate 104, 106.

The optional bottom plate 74 is applied, the polyurethane is cured, and the mold is ready for use. It can be seen that plates 102 provide product molding cavities between each adjacent plate pair and in the cavities having plates 104, 106 at one end thereof.

Having described and illustrated the principles of the invention in a preferred embodiment thereof, it should be apparent that the invention can be modified in arrangement and detail without departing from such principles. I claim all modifications and variation coming within the spirit and scope of the following claims.

1. A concrete product mold comprising:
a frame having a central opening therethrough;
a grid having at least one product-forming cavity formed therethrough, the grid being received in the central opening of the frame; and
a polymeric adhesive disposed between the outer perimeter of the grid and the inner perimeter of the frame thereby securing the grid to the frame.

2. The concrete product mold of claim 1 wherein the grid includes a plurality of product-forming cavities.

3. The concrete product mold of claim 2 wherein the grid comprises a plurality of sub-grids, each sub-grid having at least one product-forming cavity therethrough, the sub-grids being arranged side-by-side and being all received in the central opening of the frame.

4. The concrete product mold of claim 3 further comprising polymeric adhesive disposed between adjacent sub-grids.

5. The concrete product mold of claim 2 wherein the grid further comprises a pair of sub-grids and a plurality of plates extending from one sub-grid to the other, the plates forming additional product-forming cavities therebetween.

6. The concrete product mold of claim 1 wherein the grid and the frame are formed to define a slot between the two, the polymeric adhesive being received in the slot.

7. The concrete product mold of claim 4 wherein the plurality of sub-grids are formed to define a slot between adjacent sub-grids, the polymeric adhesive being received in the slot.

8. The concrete product mold of claim 1 further comprising a plate having a central opening therethrough and being disposed against one side of the frame with an inner perimeter of the plate surrounding the central opening of the frame.

9. The concrete product mold of claim 8 wherein the outer perimeter of the grid abuts against the inner perimeter of the plate in a manner that defines a space between the grid and the plate in which the polymeric adhesive is received.

10. A mold for forming a plurality of concrete products comprising:
a frame having a central opening defined by a wall formed through the frame, the wall extending between an upper surface of the frame and a lower surface;
a grid in the central opening;
a plurality of cavities formed through the grid and extending between an upper surface of the grid and a lower surface; and
a polymeric adhesive between the grid and the wall of the central opening.

11. The mold of claim 10 wherein the grid is formed from at least two sub-grids and wherein the mold further includes polymeric adhesive between the sub-grids.

12. The mold of claim 10 wherein the grid is formed from a unitary body.

13. The mold of claim 10 wherein the grid and the frame are formed to define a slot between surface of the grid and the frame wall, the polymeric adhesive being received in the slot.

14. The mold of claim 10 wherein the grid further comprises a pair of sub-grids and a plurality of plates extending from one sub-grid to the other, the plates forming additional cavities that extend between an upper surface of the grid and a lower surface.

15. The mold of claim 10 wherein the grid and the frame are formed to define a slot between the two, the polymeric adhesive being received in the slot.

16. The concrete product mold of claim 10 further comprising a plate having a central opening therethrough and being disposed against the upper surface of the frame with an inner perimeter of the plate surrounding the central opening of the frame.

17. The mold of claim 16 wherein the outer perimeter of the grid abuts against the inner perimeter of the plate in a manner that defines a space between the grid and the plate in which the polymeric adhesive is received.

18. A method of making a mold for concrete products comprising:
forming a frame having a central opening defined by a wall formed through the frame, the wall extending between an upper surface of the frame and a lower surface;
forming a grid having a plurality of cavities therethrough, the cavities extending between an upper surface of the grid and a lower surface;
inserting the grid in the central opening of the frame; and
attaching the grid to the frame with a polymeric adhesive applied between the grid and the wall of the central opening.

19. The method of claim 18 wherein forming the grid comprises forming at least two sub-grids.

20. The method of claim 20 further including attaching sub-grids to one another with a polymeric adhesive applied between the sub-grids.

21. The method of claim 20 further comprising leaving a space between the sub-grids and wherein attaching the sub-grids to one another comprises pouring the polymeric adhesive into the space.

22. The method of claim 18 further comprising leaving a space between the outer perimeter of the grid and the inner perimeter of the central frame opening and wherein attaching the grid to the frame comprises pouring the polymeric adhesive into the space.
